(19) United States
(12) Patent Application Publication
(10) Pub. No.: US 2026/0183734 A1
(43) Pub. Date: Jul. 2, 2026

(54) DEHYDROGENATION REACTION SYSTEM AND CONTROL METHOD THEREOF

(71) Applicants: HYUNDAI MOTOR COMPANY, SEOUL (KR); KIA CORPORATION, SEOUL (KR); KOREA INSTITUTE OF SCIENCE AND TECHNOLOGY, Seoul (KR)

(72) Inventors: Jihui Seo, Hwaseong-si (KR); Jaeyong Lee, Hwaseong-si (KR); Jihye Park, Hwaseong-si (KR); Ji-Hoon Jang, Hwaseong-si (KR); Pyung Soon Kim, Hwaseong-si (KR); Narae Yoon, Hwaseong-si (KR); Hanjin Kim, Hwaseong-si (KR); Suk Woo Nam, Seoul (KR); Hyuntae Sohn, Seoul (KR); Yongmin Kim, Seoul (KR); Hyangsoo Jeong, Seoul (KR); Jaewon Kirk, Seoul (KR); Chan Kim, Seoul (KR)

(73) Assignees: HYUNDAI MOTOR COMPANY, SEOUL (KR); KIA CORPORATION, SEOUL (KR); KOREA INSTITUTE OF SCIENCE AND TECHNOLOGY, Seoul (KR)

(21) Appl. No.: 19/429,270

(22) Filed: Dec. 22, 2025

(30) Foreign Application Priority Data
Dec. 27, 2024 (KR) 10-2024-0197978
Sep. 17, 2025 (KR) 10-2025-0133703

(51) Int. Cl. B01J 19/00; B01J 14/00; C01B 3/065; C01B 3/32

(52) U.S. Cl. CPC B01J 19/0013; B01J 14/00; C01B 3/065; C01B 3/32; B01J 2219/00103; B01J 2219/00186; B01J 2219/00191; C01B 2203/02

(57) ABSTRACT

An example embodiment of the present disclosure provides a dehydrogenation reaction system including a dehydrogenation reactor configured to generate a hydrogen gas through a chemical reaction between a chemical hydride aqueous solution and an acidic aqueous solution, an acid tank configured to store acid that is supplied to the dehydrogenation reactor, a chemical hydride tank storing a chemical hydride aqueous solution containing a neutralizing agent that is supplied to the dehydrogenation reactor, and a controller configured to supply a first predetermined amount of water and a second predetermined amount of acidic aqueous solution to the dehydrogenation reactor, and, after the water and the acidic aqueous solution have been supplied to the dehydrogenation reactor, to supply a chemical hydride aqueous solution to the dehydrogenation reactor at a first predetermined flow rate.

### CROSS-REFERENCE TO RELATED APPLICATION(S)

This application claims priority to and the benefit of Korean Patent Application No. 10-2024-0197978, filed with the Korean Intellectual Property Office on Dec. 27, 2024, and Korean Patent Application No. 10-2025-0133703, filed with the Korean Intellectual Property Office on Sep. 17, 2025, the entire contents of each are incorporated herein by reference.

### TECHNICAL FIELD

The disclosed subject matter relates to a dehydrogenation reaction system and a control method therefore, and more particularly, to a dehydrogenation reaction system and a control method therefore capable of improving hydrogen purity by minimizing byproducts generated during a dehydrogenation reaction process.

### BACKGROUND

Due to depletion of fossil fuels and environmental pollution issues, there is a growing demand for renewable and alternative energy sources, and hydrogen is attracting attention as a possible alternative energy source.

A fuel cell and a hydrogen combustion device use hydrogen as a reaction gas, but to apply fuel cells and hydrogen combustion devices to vehicles and various electronic products, it is useful to have a stable and continuous hydrogen supply.

Hydrogen may be supplied to a hydrogen-utilizing device from a separate hydrogen supply station. In this method, compressed hydrogen or liquefied hydrogen may be used.

In order to supply hydrogen to a fuel cell or hydrogen combustion device, an acid solution is injected into a hydride stored in a reaction vessel to generate hydrogen, and during a reaction between the hydride and the acid solution, a byproduct, such as carbon monoxide, is generated.

If byproducts, such as carbon monoxide, generated during the dehydrogenation reaction are supplied to a hydrogen supply target, such as a fuel cell, there is a possibility that deactivation problems may occur in the fuel cell.

Therefore, a technology to increase the purity of hydrogen gas by suppressing the production of byproducts, such as carbon monoxide, during the dehydrogenation reaction process may be useful.

The above information disclosed in this Background section is for the background of the disclosure, and therefore, it may contain information that does not form prior art.

### SUMMARY

Provided herein is a dehydrogenation reaction system and a control method therefore configured to increase purity of hydrogen gas by suppressing an amount of carbon monoxide generated during the dehydrogenation reaction process.

An example embodiment of the present disclosure provides a dehydrogenation reaction system including a dehydrogenation reactor configured to generate a hydrogen gas through a chemical reaction between a chemical hydride aqueous solution and an acidic aqueous solution. The system further includes an acid tank configured to store acid that is supplied to the dehydrogenation reactor, a chemical hydride tank storing a chemical hydride aqueous solution containing a neutralizing agent that is supplied to the dehydrogenation reactor, and a controller configured to supply a first predetermined amount of water and a second predetermined amount of acidic aqueous solution to the dehydrogenation reactor. After the water and the acidic aqueous solution have been supplied to the dehydrogenation reactor, the controller may supply a chemical hydride aqueous solution to the dehydrogenation reactor at a first predetermined flow rate.

In some example embodiments, the system may further include a water tank configured to store water that is supplied to the dehydrogenation reactor.

In some example embodiments, if an internal temperature of the dehydrogenation reactor exceeds a first predetermined temperature, the controller may be configured to supply a chemical hydride solution at a second predetermined flow rate, that is slower than the first predetermined flow rate, to the dehydrogenation reactor.

In some example embodiments, if an internal temperature of the dehydrogenation reactor exceeds a first predetermined temperature, the controller may be configured to (e.g., additionally) supply water to the dehydrogenation reactor.

In some example embodiments, after a third predetermined amount of chemical hydride is supplied to the dehydrogenation reactor, when an internal temperature of the dehydrogenation reactor is equal to or greater than the second predetermined temperature, the controller may be configured to additionally supply water to the dehydrogenation reactor.

In some example embodiments, after a third predetermined amount of chemical hydride is supplied to the dehydrogenation reactor, when an internal temperature of the dehydrogenation reactor is less than the second predetermined temperature, the controller may be configured to discharge a product of the dehydrogenation reactor into a product tank.

In some example embodiments, an acid solution supplied to the dehydrogenation reactor has a molar ratio within a predetermined range relative to water.

In some example embodiments, the molar ratio within the predetermined range may be from about 20 mol % to about 50 mol %. The mol % indicates molar ratio of the acid relative to water.

In some example embodiments, a thermal management device is provided in the chemical hydride tank and is configured to maintain a temperature of the chemical hydride tank within a predetermined temperature range.

In some example embodiments, the predetermined temperature range may have about 5 to about 20 degrees Celsius.

In some example embodiments, the thermal management device may include at least one of a cooling coil provided inside the chemical hydride tank, a cooling jacket provided outside the chemical hydride tank, or a cooling bath configured to accommodate the chemical hydride tank therein.

In some example embodiments, an operating temperature for a reaction between the acidic aqueous solution and the chemical hydride aqueous solution in the dehydrogenation reactor may be maintained at or below about 120 degrees Celsius.

An example embodiment of the present disclosure provides a control method for a dehydrogenation reaction system. The method may include supplying a first predetermined amount of water to a dehydrogenation reactor, supplying a second predetermined amount of acid aqueous solution to the dehydrogenation reactor, and supplying a chemical hydride containing a neutralizing agent to the dehydrogenation reactor at a first predetermined flow rate, after the water and the acidic aqueous solution have been supplied to the dehydrogenation reactor.

In some example embodiments, the method may further include determining whether an internal temperature of the dehydrogenation reactor exceeds a first predetermined temperature, and supplying the chemical hydride solution to the dehydrogenation reactor at a second predetermined flow rate that is slower than the first predetermined flow rate when the internal temperature of the dehydrogenation reactor exceeds the first predetermined temperature.

In some example embodiments, the method may further include determining whether a third predetermined amount of chemical hydride aqueous solution has been supplied to the dehydrogenation reactor, determining whether the internal temperature of the dehydrogenation reactor is below a second predetermined temperature after a third predetermined amount of chemical hydride aqueous solution has been supplied to the dehydrogenation reactor, and discharging a product of the dehydrogenation reactor to a product tank or additionally supplying water to the dehydrogenation reactor based on the internal temperature of the dehydrogenation reactor.

In some example embodiments, the method may further include if an internal temperature of the dehydrogenation reactor is less than a second predetermined temperature, discharging the product of the dehydrogenation reactor into the product tank.

In some example embodiments, the method may further include if an internal temperature of the dehydrogenation reactor is equal to or greater than a second predetermined temperature, additionally supplying water to the dehydrogenation reactor.

In some example embodiments, an acidic aqueous solution supplied to the dehydrogenation reactor has a molar ratio within a predetermined range relative to the water.

In some example embodiments, the molar ratio within the predetermined range may be from about 20 mol % to about 50 mol %.

In some example embodiments, the chemical hydride tank may maintain a predetermined temperature range.

In some example embodiments, the predetermined temperature range may have about 5 to about 20 degrees Celsius.

According to the example embodiments, by first injecting the acidic aqueous solution into the dehydrogenation reactor and then injecting the chemical hydride aqueous solution, generation of a byproduct such as carbon monoxide, which may occur during the reaction between the acidic aqueous solution and the chemical hydride aqueous solution, may be minimized.

Further, effects that can be obtained or expected from example embodiments of the present disclosure are described herein the following detailed description.

### BRIEF DESCRIPTION OF THE DRAWINGS

The drawings are intended to be used as references for describing the present disclosure, and the accompanying drawings should not be construed as limiting the present disclosure.

FIG. 1 illustrates a schematic view showing a configuration of a dehydrogenation reaction system according to an example embodiment.

FIGS. 2A, 2B, and 2C illustrate schematic views showing a configuration of a thermal management apparatus according to an example embodiment.

FIG. 3 illustrates a flowchart showing a control method for a dehydrogenation reaction system according to an example embodiment.

FIG. 4A and FIG. 4B illustrate an experimental result for verifying a first method of injecting an acidic aqueous solution and a chemical hydride.

FIG. 5A and FIG. 5B illustrate an experimental result for verifying a second method of injecting an acidic aqueous solution and a chemical hydride.

FIG. 6 illustrates an experimental result for verifying a third method of injecting an acidic aqueous solution and a chemical hydride.

FIGS. 7A and 7B illustrate charts showing an experimental result for identifying a factor that affects generation of carbon monoxide.

FIG. 8 illustrates a view for describing part of the experimental result presented in FIGS. 7a and 7b.

FIG. 9 illustrates a relationship between an amount of H2O charged and a maximum amount of CO generated, based on the experimental result shown in FIGS. 7A and 7B.

FIGS. 10A, 10B, 10C, and 10D illustrate graphs showing a portion of the experimental result shown in FIGS. 7A and 7B.

FIG. 11 illustrates a chart for describing part of the experimental result presented in FIGS. 7A and 7B.

The drawings are not necessarily drawn to scale, but rather present a somewhat simplified representation of various features to illustrate basic principles of the present disclosure. Certain design features of the present disclosure (e.g., particular dimensions, orientations, positions, and shapes) may be determined in part by the intended application and usage environment.

### DETAILED DESCRIPTION

The terms used herein are for describing specific example embodiments and are not intended to limit the scope of the present disclosure. As used herein, singular forms are intended to include plural forms as well, unless stated otherwise in the context. The terms “comprise” and/or “comprising,” when used herein, provide the recited features, integers, steps, acts, elements and/or presence of components, but this does not exclude the presence or addition of one or more of other features, integers, steps, acts, elements, components, and/or groups thereof. As used herein, the term “and/or” includes any one or all combinations of the associated listed items.

Additionally, one or more of the following methods or aspects thereof may be executed by at least one controller. The term “controller” may refer to a hardware device that includes a memory and a processor.

The memory is configured to store program instructions, and the processor is (e.g., specifically) programmed to execute the program instructions to perform one or more processes described in further detail herein. The controller, as described herein, may control operations of units, modules, components, devices, or similar elements. Furthermore, the following methods may be executed by a device that includes a controller along with one or more other components.

Additionally, the controller of the present disclosure may be implemented as a non-transitory computer-readable recording medium containing executable program instructions executed by a processor. Examples of the computer-readable recording media include, but are not limited to, a ROM, a RAM, a compact disk (CD) ROM, a magnetic tape, a floppy disk, a flash drive, a smart card, and an optical data storage device. The computer-readable recording medium may also be distributed across a computer network so that program instructions can be stored and executed in a distributed manner, such as on a telematics server or a controller area network (CAN).

The present disclosure will be described more fully hereinafter with reference to the accompanying drawings, in which embodiments of the disclosure are shown. However, the described embodiments of the present disclosure may be modified in various (e.g., different) ways, without departing from the spirit or scope of the present disclosure.

To describe the present disclosure, like numerals refer to like or similar components throughout the specification.

In addition, since the size and thickness of each configuration shown in the drawings are shown for convenience, the present disclosure is not necessarily limited to configurations illustrated and in order to illustrate several parts and areas, enlarged thicknesses may be shown.

Terms “module” and/or “unit” for components used in the following description are used in order to describe the specification. Therefore, these terms may not have meanings or roles that distinguish them from each other in and of themselves.

The accompanying drawings are provided in order to allow example embodiments disclosed in the present specification to be understood and are not to be interpreted as the present specification. The present disclosure includes (e.g., all) modifications, equivalents, and substitutions without departing from the present disclosure.

Terms including ordinal numbers such as first, second, and the like will be used to describe various components and are not to be interpreted as limiting these components.

In the descriptions below, expressions written in the singular may be construed in the singular or plural unless an explicit expression such as “one” or “single” is used.

The terms are used to differentiate one component from other components.

In a flowchart described with reference to the drawings, an order of operations may be changed, several operations may be merged, some operations may be divided, and one or more operations may not be performed.

Hereinafter, a dehydrogenation reaction according to an example embodiment is described in detail with reference to the attached drawings.

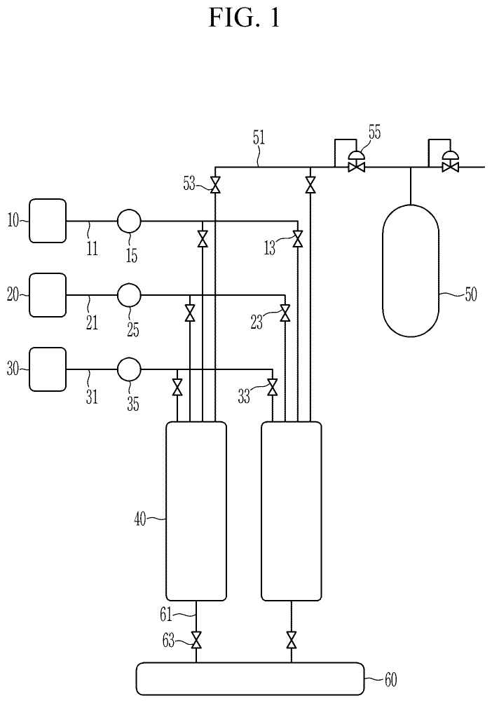

FIG. 1 illustrates a schematic view showing a configuration of a dehydrogenation reaction system according to an example embodiment.

As illustrated in FIG. 1, the dehydrogenation reaction system according to an example embodiment may include a water tank 10, an acid tank 20, a chemical hydride tank 30, a dehydrogenation reactor 40, a hydrogen tank 50, and a product tank 60.

The water tank 10 may store water, and the water stored in the water tank 10 may be (e.g., selectively) supplied to the dehydrogenation reactor 40. A water valve 13 may be provided in a water supply line 11 that fluidly connects the water tank 10 and the dehydrogenation reactor 40, and water may be supplied to the dehydrogenation reactor 40 according to opening and closing of the water valve 13. In addition, a water pump 15 may be provided in the water supply line 11, and water stored in the water tank 10 may be pressurized through the water pump 15 to be supplied to the dehydrogenation reactor 40.

The acid tank 20 may store acid (hereinafter, referred to as “FA”) and/or an acid aqueous solution, and the acid and/or acid aqueous solution stored in the acid tank 20 may be (e.g., selectively) supplied to the dehydrogenation reactor 40. An acid valve 23 may be provided in an acid supply line 21 that fluidly connects the acid tank 20 and the dehydrogenation reactor 40, and an acid solution may be supplied to the dehydrogenation reactor 40 according to opening and closing of the acid valve 23. In addition, an acid pump 25 may be provided in the acid supply line 21, and the acid solution stored in the acid tank 20 may be pressurized through the acid pump 25 to be supplied to the dehydrogenation reactor 40.

The acid tank 20 may be formed with a corrosion-resistant protective film, such as a Teflon coating, to prevent corrosion by acid. The acid promotes a dehydrogenation reaction by adjusting pH of a chemical hydride, thereby shortening its half-life.

The acid applicable herein may be an inorganic acid, such as sulfuric acid, nitric acid, phosphoric acid, boric acid, or hydrochloric acid; a heteropoly acid; an organic acid such as acetic acid, formic acid, malic acid, citric acid, tartaric acid, ascorbic acid, lactic acid, oxalic acid, succinic acid, or taurine acid, and/or a mixture thereof. Formic acid (HCOOH) may be used due to its lower molecular weight relative to hydrogen ions, which contributes to reducing an overall system weight, and its (e.g., superior) safety compared to hydrochloric acid under a high-concentration condition.

As a weak acid, formic acid may be stably maintained at a low pH under a predetermined condition, thereby providing (e.g., enabling) relatively safe usage. In addition, carbon dioxide may be a key substance in terms of recycling and recirculation because captured carbon dioxide may be obtained through hydrogenation. Additionally, formate may be converted into bicarbonate through the dehydrogenation reaction, during which additional hydrogen may be obtained.

The chemical hydride tank 30 may store chemical hydride in an aqueous solution state, and the stored chemical hydride aqueous solution (hereinafter, referred to as “SBH aqueous solution”) may be (e.g., selectively) supplied to the dehydrogenation reactor 40. A hydride valve 33 may be provided in a hydride supply line 31 that fluidly connects the chemical hydride tank 30 and the dehydrogenation reactor 40, and a chemical hydride aqueous solution may be supplied to the dehydrogenation reactor 40 according to opening and closing of the hydride valve 33. In addition, a hydride pump 35 may be provided in the hydride supply line 31, and the chemical hydride aqueous solution stored in the chemical hydride tank 30 may be pressurized through the hydride pump 35 to be supplied to the dehydrogenation reactor 40.

The chemical hydride may be provided as an aqueous solution in which it is dissolved in water. An alkaline neutralizing agent, such as NaOH, NaBO₂, KOH, LiOH, or CsOH, may be mixed into an aqueous solution of the chemical hydride to prevent a reaction between the chemical hydride and water.

To reduce carbon monoxide, which is a byproduct generated during the reaction between the chemical hydride and the acidic aqueous solution, it may be useful (e.g., necessary) to delay a hydrolysis reaction within the chemical hydride solution.

To retard the hydrolysis of the chemical hydride aqueous solution, methods such as adjusting the pH and controlling the temperature of the chemical hydride solution may be employed.

When the chemical hydride is stored in the chemical hydride tank 30 before reacting with the acid solution, the pH may be increased by adding an alkaline substance (e.g., NaOH, NaBO₂, KOH, LiOH, or CsOH) to delay the hydrolysis reaction. As an amount of alkaline substance added increases, more neutralization reaction heat may be generated when reacting with the acid solution, and an internal temperature of the dehydrogenation reactor 40 may increase, which may increase an amount of carbon monoxide generated.

To prevent or minimize these challenges, when storing chemical hydride, an amount of alkaline substance added may be reduced by lowering a temperature of the chemical hydride tank 30. However, if the temperature of the chemical hydride tank 30 is lowered too much, solubility of the chemical hydride may decrease, so a temperature of the chemical hydride tank 30 may be maintained within a predetermined temperature range (e.g., about 5 to about 20 degrees Celsius).

The chemical hydride tank 30 may include a thermal management device. The thermal management device may be intended to maintain a temperature of the chemical hydride tank 30 within a predetermined temperature range.

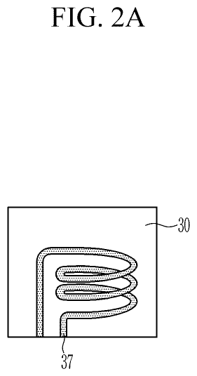

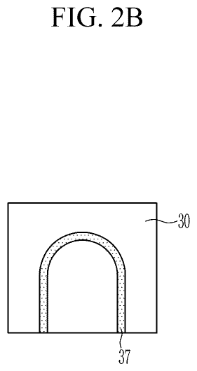

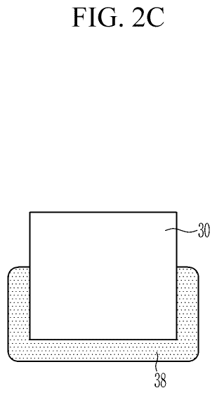

Referring to FIGS. 2A and 2B, the thermal management device may be a cooling coil 37 provided inside the chemical hydride tank 30. Coolant (or heat medium oil) may circulate in the cooling coil 37, and the temperature of the chemical hydride tank 30 may be controlled by circulation of the coolant (or heat medium oil). The cooling coil 37 may be provided in a coil shape inside the chemical hydride (see FIG. 2A) or may be provided in a U shape inside the chemical hydride (FIG. 2B).

Referring to FIG. 2C, the thermal management device may be a cooling jacket 38 provided outside the chemical hydride tank 30. Coolant (or heat medium oil) may circulate in the cooling jacket 38, and the temperature of the chemical hydride tank 30 may be controlled by circulation of the coolant (or heat medium oil).

Alternatively, the thermal management device may be a cooling bath 38 housing the chemical hydride tank 30. Coolant (or heat medium oil) may circulate in the cooling bath 38, and the temperature of the chemical hydride tank 30 may be controlled by circulation of the coolant (or heat medium oil).

The dehydrogenation reactor 40 may produce hydrogen gas by a chemical reaction between the chemical hydride and the acid aqueous solution.

The dehydrogenation reactor 40 may be configured as a high-temperature and high-pressure vessel to provide (e.g., enable) the dehydrogenation reaction to proceed under high-temperature and high-pressure conditions. For example, the dehydrogenation reactor 40 may have a spherical, rectangular, or polygonal prism shape, and in an example embodiment, the dehydrogenation reactor 40 may have a cylindrical shape.

High-pressure hydrogen gas generated in the dehydrogenation reactor 40 may be optionally stored in the hydrogen tank 50. A hydrogen discharge line 51 fluidly connecting the dehydrogenation reactor 40 and the hydrogen tank 50 may be provided with a hydrogen back pressure regulator 55, and a hydrogen valve 53 may be provided upstream of the hydrogen back pressure regulator 55. High-pressure hydrogen gas generated in the dehydrogenation reactor 40 may be supplied to the hydrogen tank 50 in response to opening and closing of the hydrogen valve 53. High-pressure hydrogen gas stored in the hydrogen tank 50 may be supplied to a high-pressure charging target.

To (e.g., stably) extract hydrogen from the dehydrogenation reactor 40, an internal pressure of a reaction vessel of the dehydrogenation reactor 40 may be increased to a predetermined level (e.g., about 500 bar), thereby adjusting a boiling point of a reactant (e.g., about 100° C. to about 400° C.) and minimizing phase changes of the reactant. By installing the hydrogen pressure regulator 55 downstream of the dehydrogenation reactor 40, the internal pressure of the reaction vessel of the dehydrogenation reactor 40 may be controlled.

A product generated by the dehydrogenation reaction in the dehydrogenation reactor 40 may be stored in the product tank 60. A product discharge line 61 fluidly connecting the dehydrogenation reactor 40 and the product tank 60 may be provided with a product valve 63, and the product generated in the dehydrogenation reactor 40 may be discharged into the product tank 60 in response to opening and closing of the product valve 63.

Hydrogen gas may be generated by reaction of the reactant within the dehydrogenation reactor 40, and as an amount of hydrogen gas increases, an internal pressure of the dehydrogenation reactor 40 may (e.g., gradually) rise. When the internal pressure of the dehydrogenation reactor 40 reaches a predetermined pressure, the hydrogen gas may be discharged into the hydrogen tank 50. As the hydrogen gas within the dehydrogenation reactor 40 is discharged into the hydrogen tank 50, the internal pressure of the dehydrogenation reactor 40 may decrease. When (e.g., all) reactions in the dehydrogenation reactor 40 are completed and (e.g., all) hydrogen gas is discharged into the hydrogen tank 50, the product in the dehydrogenation reactor 40 may be discharged into the product tank 60 while the pressure in the dehydrogenation reactor 40 is decreased (e.g., lowered).

For example, when the chemical hydride is NaBH₄ and the acid is HCOOH, a dehydrogenation reaction as shown in Reaction Scheme 1 occurs.

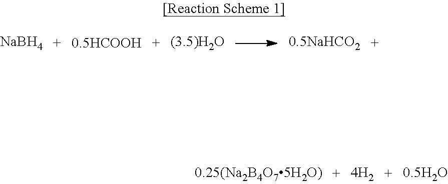

For example, the product may include NaHCO₂, Na₂B₄O₇·5H₂O, and H₂O, which are generated by the dehydrogenation reaction.

Meanwhile, a dehydrogenation reaction system according to an example embodiment may include a controller configured to supply an acidic aqueous solution to the dehydrogenation reactor 40, (e.g., subsequently) supply a liquid chemical hydride to the dehydrogenation reactor 40, discharge hydrogen gas from the dehydrogenation reactor 40 to the hydrogen tank 50 when the internal pressure of the dehydrogenation reactor 40 reaches a predetermined pressure, and discharge the product generated in the dehydrogenation reactor 40 to the product tank 60 upon completion of the dehydrogenation reaction.

The controller may be implemented by one or more processors operating according to a predetermined program (e.g., instructions), and the memory of the controller may store program instructions programmed to execute each operation (e.g., instruction) of the control method of the dehydrogenation reaction system according to the present disclosure via the one or more processors.

Meanwhile, a dehydrogenation reaction system according to an example embodiment may include a temperature sensor configured to detect an internal temperature of the dehydrogenation reactor 40, a first mass sensor configured to measure a weight of water stored in the water tank 10, a second mass sensor configured to measure a weight of acid stored in the acid tank 20, and a third mass sensor configured to measure a weight of a chemical hydride aqueous solution containing a neutralizing agent stored in the chemical hydride tank 30.

The temperature of the dehydrogenation reactor 40 measured by the temperature sensor, the weight of water measured by the first mass sensor, the weight of acid measured by the second mass sensor, and the weight of the chemical hydride aqueous solution measured by the third mass sensor may be transmitted to the controller.

Hereinafter, a control method for a dehydrogenation reaction system according to an example embodiment will be described in detail with reference to the attached drawings.

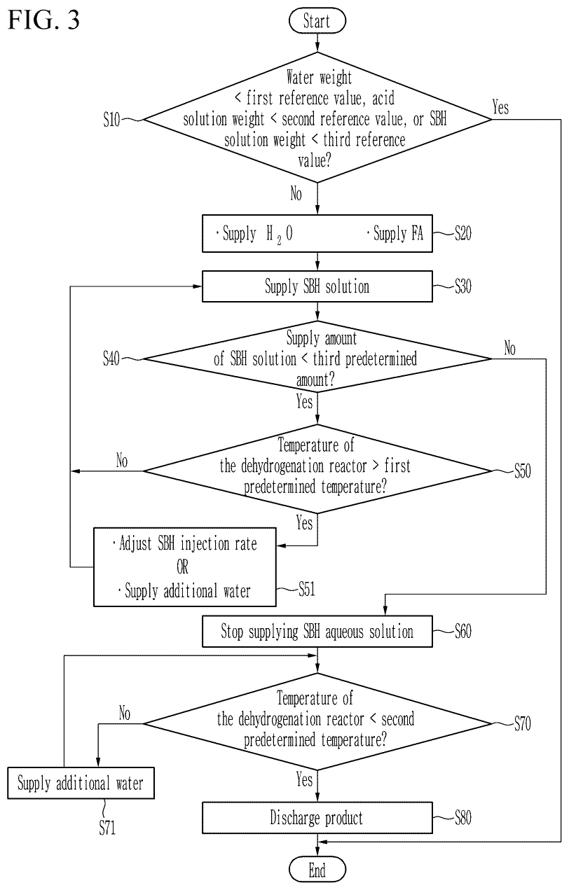

FIG. 3 illustrates a flowchart showing a control method for a dehydrogenation reaction system according to an example embodiment.

Referring to FIG. 3, the controller may determine whether the weight of water stored in the water tank 10 is less than a first reference value (e.g., about 200 g), whether the weight of acid stored in the acid tank 20 is less than a second reference value (e.g., about 100 g), and/or whether the weight of the chemical hydride aqueous solution containing the neutralizing agent stored in the chemical hydride tank 30 is less than a third reference value (e.g., about 600 g) (S10).

In an example embodiment, the first to third reference values may represent the respective weights of reactants required for a single reaction cycle in the dehydrogenation reactor 40.

If the weight of water stored in the water tank 10 is less than the first reference value, or the weight of acid stored in the acid tank 20 is less than the second reference value, or the weight of the chemical hydride aqueous solution containing the neutralizing agent stored in the chemical hydride tank 30 is less than the third reference value, the controller may output an error message and terminate the operation.

In Operation S10, if the weight of water, acid, and chemical hydride are each equal to or greater than their respective reference values, the controller may supply a first predetermined amount of water (e.g., about 50 g) and a second predetermined amount of acid (e.g., about 85 g) to the dehydrogenation reactor 40 (S20).

The controller may open the water valve 13 provided in the water supply line 11 and operate the water pump 15 to supply water from the water tank 10 to the dehydrogenation reactor 40. In addition, the controller may open the acid valve 23 provided in the acid supply line 21 and operate the acid pump 25 to supply acid from the acid tank 20 to the dehydrogenation reactor 40.

The acid supplied to the dehydrogenation reactor 40 may be provided at a molar ratio within a predetermined range relative to the water. The molar ratio within the predetermined range may be from about 20 mol % to about 50 mol %.

After the water and the acid are supplied to the dehydrogenation reactor 40, the controller may supply the chemical hydride aqueous solution containing the neutralizing agent to the dehydrogenation reactor 40 at a first predetermined flow rate (e.g., about 30 ml/min) (S30).

The controller may open the chemical hydride valve 33 provided in the chemical hydride supply line 31 and operate the chemical hydride pump 35 to supply the chemical hydride aqueous solution from the chemical hydride tank 30 to the dehydrogenation reactor 40.

The controller may determine whether an amount of chemical hydride solution supplied to the dehydrogenation reactor 40 exceeds a third predetermined amount (e.g., about 500 g) (S40).

If the amount of chemical hydride solution supplied to the dehydrogenation reactor 40 is less than the third predetermined amount, the controller may determine whether the internal temperature of the dehydrogenation reactor 40 exceeds a first predetermined temperature (e.g., about 160 degrees Celsius) (S50).

In Operation S50, if the internal temperature of the dehydrogenation reactor 40 exceeds the first predetermined temperature, the controller may decrease (e.g., lower) a flow rate of the chemical hydride solution supplied to the dehydrogenation reactor 40 to a second predetermined flow rate (e.g., about 20 ml/min) and supply it to the dehydrogenation reactor 40 (S51). By lowering the supply flow rate of the chemical hydride aqueous solution, a reaction temperature of the acid aqueous solution and the chemical hydride aqueous solution in the dehydrogenation reactor 40 (or the internal temperature of the dehydrogenation reactor 40) may be lowered. By lowering the reaction temperature in the dehydrogenation reactor 40 (or the internal temperature of the dehydrogenation reactor 40), production of by-products (e.g., carbon monoxide, etc.) generated by a reaction between the acid solution and the chemical hydride solution may be minimized, and purity of hydrogen gas may be increased.

Alternatively, the controller may additionally supply a predetermined amount of water (e.g., about 10 g) to the dehydrogenation reactor 40 (S51). The reaction between the acidic aqueous solution and the chemical hydride occurring in the dehydrogenation reactor 40 may be an exothermic reaction. Accordingly, by additionally supplying water to the dehydrogenation reactor 40, the internal temperature of the dehydrogenation reactor 40 may be reduced, thereby minimizing generation of byproducts (e.g., carbon monoxide) resulting from the reaction between the acidic aqueous solution and the chemical hydride aqueous solution, and may improve (e.g., enhance) the purity of the hydrogen gas.

In Operation S50, if the internal temperature of the dehydrogenation reactor 40 is below the first predetermined temperature, the controller may (e.g., continuously) supply the chemical hydride aqueous solution to the dehydrogenation reactor 40, or may supply the chemical hydride aqueous solution at the first predetermined flow rate.

In Operation S50, if the internal temperature of the dehydrogenation reactor 40 is below the first predetermined temperature, the controller may (e.g., continuously) supply the chemical hydride aqueous solution to the dehydrogenation reactor 40, or may supply the chemical hydride aqueous solution at the first predetermined flow rate. The controller may close the hydride valve 33 and stop an operation of the hydride pump 35.

The controller may determine whether the internal temperature of the dehydrogenation reactor 40 is below a second predetermined temperature (e.g., about 80° C.) (S70). The second predetermined temperature may be less than the first predetermined temperature.

If the internal temperature of the dehydrogenation reactor 40 is equal to or greater than the second predetermined temperature, the controller may additionally supply water to the dehydrogenation reactor 40 (S71). The controller may open the water valve 13 provided in the water supply line 11 and operate the water pump 15 to supply water from the water tank 10 to the dehydrogenation reactor 40.

If the internal temperature of the dehydrogenation reactor 40 is below the second set temperature, the controller may discharge the product generated in the dehydrogenation reactor 40 to the product tank 60 (S80). The controller may open the product valve 63 provided in the product supply line 11.

The product generated in the dehydrogenation reactor 40 may be formed in a slurry-like state, and when the temperature of the dehydrogenation reactor 40 is high, it may be challenging to process the product. Accordingly, by additionally supplying water to the dehydrogenation reactor 40, a temperature of the product may be lowered, and the product may then be recovered.

According to an example embodiment, an acidic aqueous solution may first be supplied into the dehydrogenation reactor 40, and subsequently, a chemical hydride aqueous solution containing a neutralizing agent may be gradually supplied to induce a dehydrogenation reaction. Through this process, generation of byproducts such as carbon monoxide, which may occur during the reaction between the chemical hydride aqueous solution and the acidic aqueous solution, may be minimized, thereby increasing (e.g., enhancing) purity of the hydrogen gas. Hereinafter, a principle by which the purity of hydrogen gas may be increased (e.g., enhanced) through initial introduction of an acidic aqueous solution into the dehydrogenation reactor 40 is provided herein.

There are three example methods for introducing a reactant into the dehydrogenation reactor 40.

A first method is to add an acid solution to a solid chemical hydride (NaBH₄ (solid)←Formic acid+H₂O (solution)). A second method is to add the acid solution to a chemical hydride solution containing a neutralizing agent (NaBH₄+NaOH+H₂O (solution)←Formic acid+H₂O (solution)). A third method is to add a chemical hydride solution containing a neutralizing agent to an acid solution (Formic acid+H₂O (solution)←NaBH₄+NaOH+H₂O (solution)).

Hereinafter, a detailed description of each method is provided through an experiment.

The first method provides a high hydrogen storage density (e.g., about 5 weight % (wt %) to about 6 wt % H₂). When using a small capacity reactor to cope with a high pressure system, local overreaction may occur due to poor fluidity. Additionally, when moving on to a nth reaction after a first reaction, there may be a challenge in handling a residue and residual hydrogen.

The first method of injecting acid solution and chemical hydride was confirmed through experiments.

Experimental conditions for the first method are as follows. The dehydrogenation reactor 40 has a capacity of 370 mL, and 100 g of a chemical hydride is used, and an acidic aqueous solution (FA solution) corresponding to four equivalents of the chemical hydride is added, and an injection rate of the acidic aqueous solution is 4 mL/min.

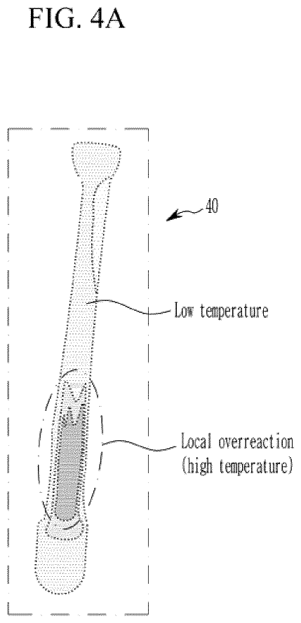

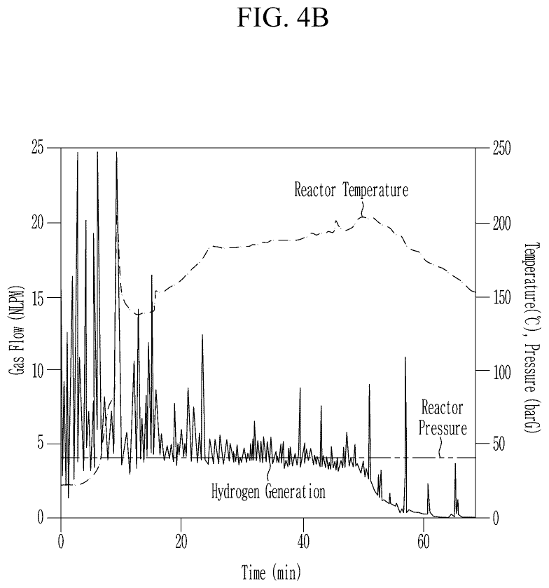

Referring to FIG. 4A, as shown, the external temperature of the dehydrogenation reactor 40 exhibits localized regions of high and low temperatures, which indicates that localized overreaction occurs within the dehydrogenation reactor 40, and that some unreacted regions remain. As a result, an uneven reaction of the chemical hydride and a temperature gradient may make it challenging to control the reaction rate and temperature.

Referring to FIG. 4B, as shown, an elevated reaction temperature in the dehydrogenation reactor 40 increases likelihood of generating gaseous impurities, such as carbon monoxide (CO) and/or methane (CH₄). It may also be shown (e.g., confirmed) that the reaction of the solid-phase chemical hydride (NaBH₄) results in insufficient fluidity of the reactant.

In the second method, use of a large initial amount of chemical hydride (NaBH₄) may result in excessive reaction heat, making it challenging to control the reaction and potentially leading to a hazardous condition.

The second method of injecting acid solution and chemical hydride was confirmed through experiments.

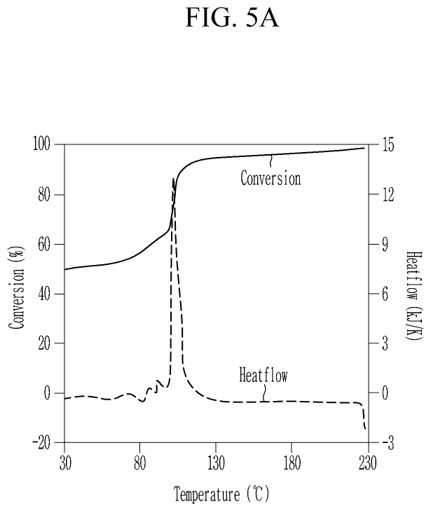

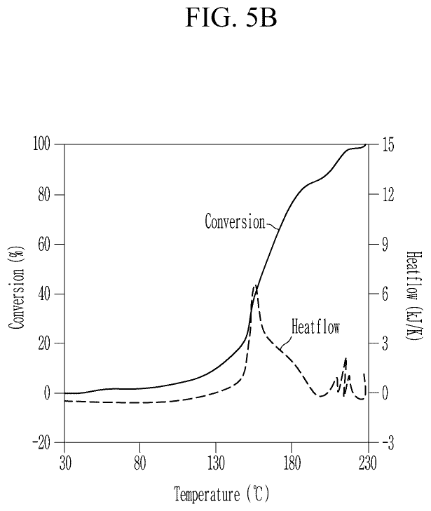

Experimental conditions for the second method are as follows. After injecting 300 mg of a chemical hydride aqueous solution, an acidic aqueous solution (FA solution) corresponding to four equivalents of the chemical hydride (see FIG. 5A), or water (H₂O) (see FIG. 5B) into the reactor, the system was heated at a rate of 0.2° C./min, and heat generation and hydrogen conversion rate were measured.

Referring to FIG. 5A, it is confirmed that a rapid reaction occurs in the dehydrogenation reactor 40 (e.g., immediately) after injection of an aqueous solution (FA). In addition, referring to FIG. 5B, it may be confirmed that an abrupt reaction occurs in the dehydrogenation reactor 40 upon reaching a (e.g., specific) threshold temperature.

This may be due to an excessive amount of reactants (SBH and H₂O) within the reactor, which, upon meeting threshold conditions (e.g., temperature, catalyst), triggers a rapid reaction. Accordingly, in a dehydrogenation system with a large scale and limited heat dissipation capability, a temperature rise may tend to be more rapid, resulting in challenges in controlling the reaction.

The third method provides an improvement of providing (e.g., enabling) control over the reaction temperature and rate through a reaction between a liquid-phase chemical hydride aqueous solution and a liquid-phase acidic aqueous solution. Furthermore, temperature control may be feasible, thereby preventing (or minimizing) the formation of gaseous impurities, such as carbon monoxide (CO) and/or methane (CH₄). In addition, the residue generated after the reaction between the chemical hydride aqueous solution and the acidic aqueous solution is (e.g., entirely) in liquid phase, so the resulting product may be (e.g., easily) handled.

The third method of injecting acid solution and chemical hydride was confirmed through experiments.

Experimental conditions for the third method are as follows. The dehydrogenation reactor 40 has a capacity of 370 mL, and the chemical hydride aqueous solution has wt % sodium borohydride (SBH), 5 wt % sodium hydroxide (NaOH), and 70 wt % water (H₂O). The injection rate of the chemical hydride aqueous solution is 20 mL/min for 10 minutes, corresponding to 50 g of SBH, and the preheating temperature is 60° C. The hydrogen conversion rate is approximately 85%, and the hydrogen density based on the reaction material is about 3.3 wt %.

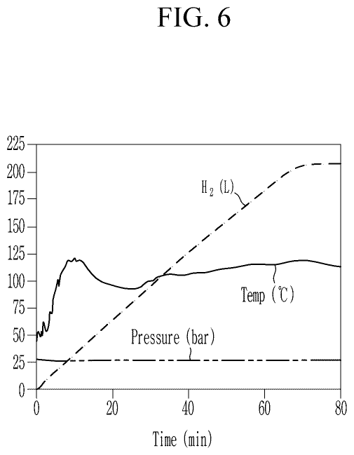

Referring to FIG. 6, it may be confirmed that a reaction temperature between the acidic aqueous solution and the chemical hydride may be controlled below 120° C. That is, an operating temperature for the reaction between the acidic aqueous solution and the chemical hydride aqueous solution in the dehydrogenation reactor may be maintained at or below 120° C. As such, by controlling the reaction temperature to remain below 120° C., generation of a gaseous by-product such as carbon monoxide (CO) may be minimized. In addition, it may be confirmed that the product is recoverable (e.g., easy to recover) because water equivalent is high and (e.g., all) reactants are (e.g., completely) liquid.

As such, the third method offers an improvement of controllable reaction temperature and rate, as it involves a reaction between a liquid-phase acidic aqueous solution and a liquid-phase chemical hydride. Furthermore, ability to control the reaction temperature may allow for minimization of by-product formation, such as carbon monoxide (CO) and methane (CH₄). In addition, the product generated from the reaction between the acidic aqueous solution and the chemical hydride is also in liquid phase, so handling of the product may be facilitated.

Based on this experimental result, it may be confirmed that the third method is an improvement in terms of providing (e.g., ensuring) reaction stability and control/system continuity. For example, under a high-pressure condition, a fixed-type reactor may be employed to reduce hydrogen gas loss and provide (e.g., ensure) safety; therefore, the third method, in which both reactants and products are in liquid phase, is an improvement. Accordingly, in an example, by first injecting the acid an aqueous solution and then injecting the chemical hydride an aqueous solution, reaction stability may be secured and control/system continuity may be secured.

Hereinafter, a method for reducing carbon monoxide (CO) by-products generated in the third method is provided herein. be described.

In the third method, an experiment was conducted by varying seven parameters to identify a most influential factor impacting (e.g., affecting) carbon monoxide (CO) generation, while measuring hydrogen conversion, hydrogen density, reactor peak temperature, and maximum CO concentration.

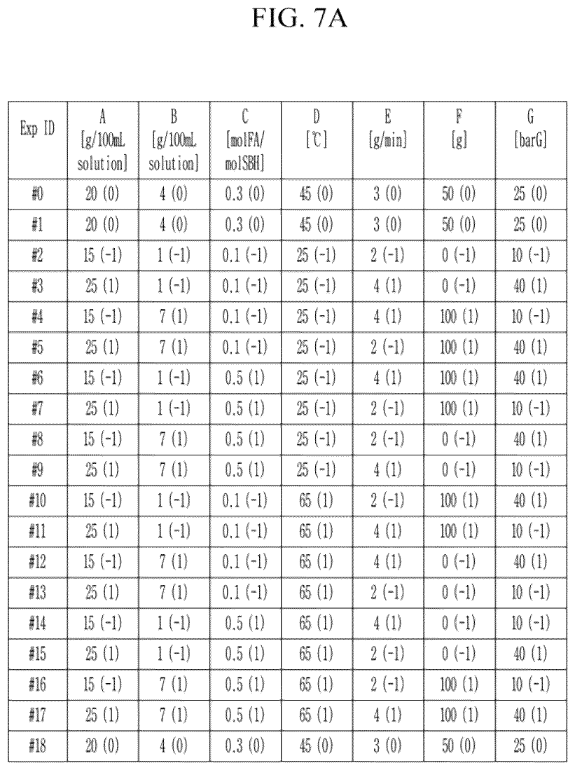

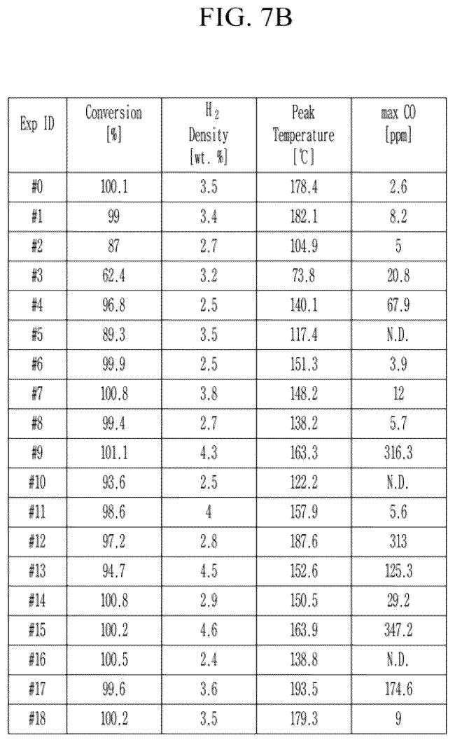

Referring to FIGS. 7A and 7B, the seven variables include: (A) concentration of the chemical hydride aqueous solution (SBH concentration); (B) concentration of the neutralizing agent (NaOH concentration); (C) excess injection amount of formic acid (excess FA); (D) initial reaction temperature; (E) injection rate of the SBH aqueous solution; (F) amount of water loaded into the reactor (FA aqueous solution concentration); and (G) internal pressure of the reactor.

Herein, the injection amount of the SBH aqueous solution is about 100 g, and the injection volume of the preloaded acidic aqueous solution may be determined based on the amount of the SBH aqueous solution.

Additionally, the SBH solution contains NaOH (neutralizing agent) to prevent SBH from reacting with water. During the reaction process, in order for the acid catalytic effect to occur, the amount of acid aqueous solution may (e.g., must) be injected in excess of the amount of NaOH contained in the SBH aqueous solution. Accordingly, the amount of formic acid (FA) injected in excess of the quantity required to react with the SBH aqueous solution, corresponding to the amount of NaOH contained in the SBH solution, may be defined as the excess FA injection volume.

Referring to FIGS. 7A and 7B, a review of the experimental results summarized in terms of peak temperature and carbon monoxide (CO) generation indicates that, in general, CO generation increases sharply when the temperature exceeds approximately 160° C.

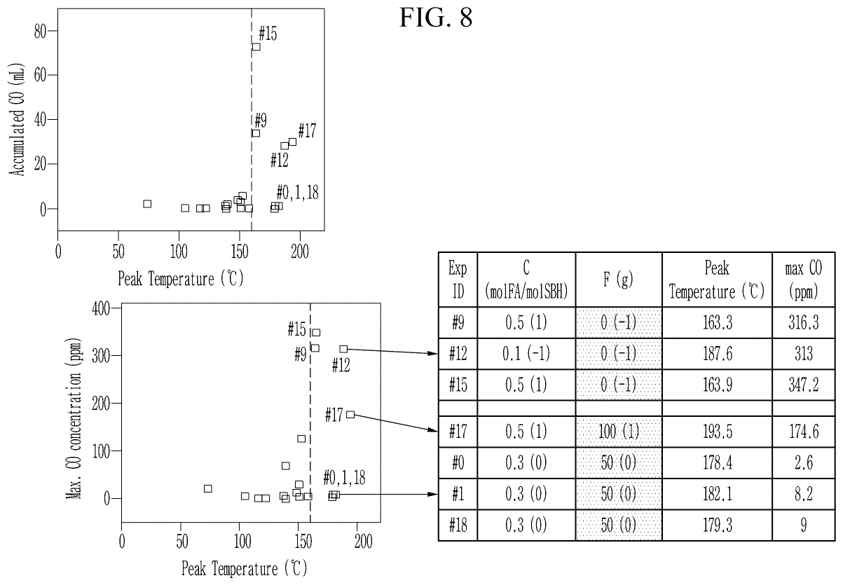

However, despite similar peak temperatures exceeding 160° C., there were (e.g., exceptional) experiments (e.g., experiments #0, #1, #18) in which the amount of carbon monoxide (CO) generated was (e.g., significantly) lower. It was confirmed that the (e.g., exceptional) experiments commonly involved use of a formic acid (FA) aqueous solution, rather than 100% FA, resulting in lower acid catalyst concentrations (see FIG. 8). For reference, the concentration of the formic acid (FA) aqueous solution in experiment #17 was 26.7 mol %, whereas in experiments #0, #1, and #18, the FA aqueous solution concentration was 31.8 mol %.

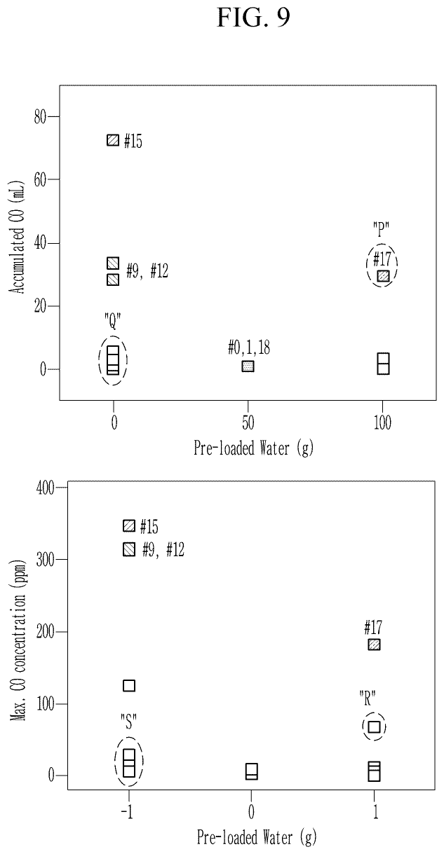

FIG. 9 illustrates a variation in maximum carbon monoxide (CO) generation as a function of the amount of water (H₂O) loaded into the reactor. It was confirmed that experiments involving the co-loading of water (H₂O) with formic acid (FA), such as in cases #0 and #1, resulted in lower carbon monoxide (CO) generation compared to a case without water loading #(−1).

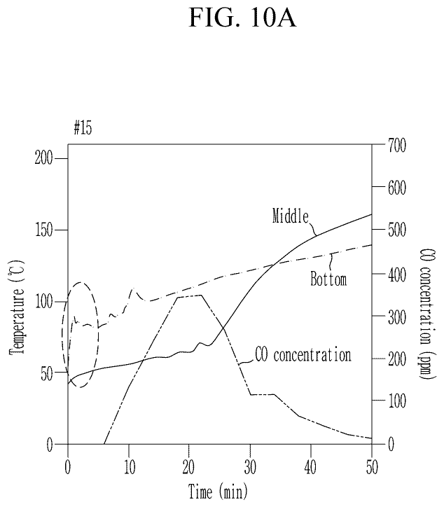

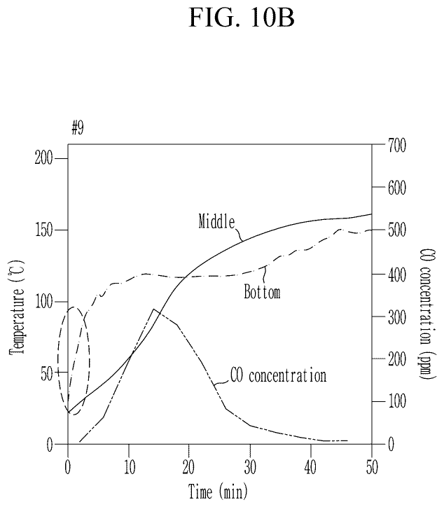

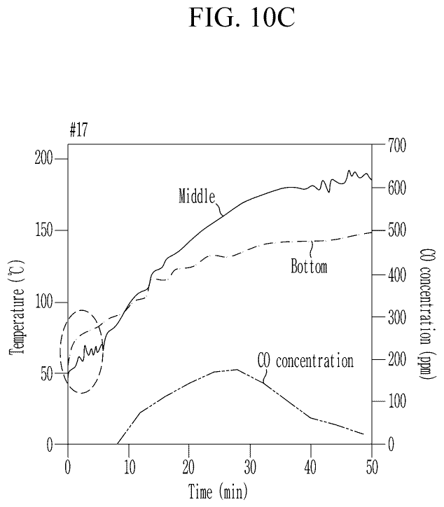

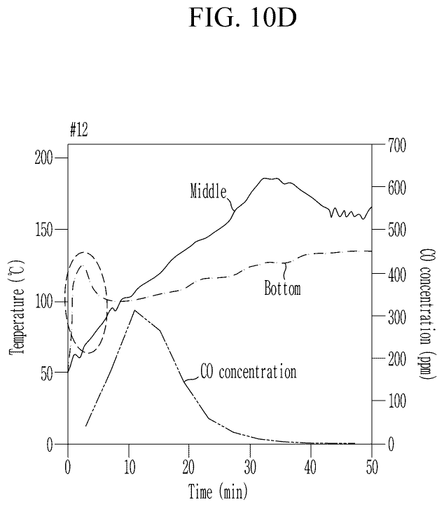

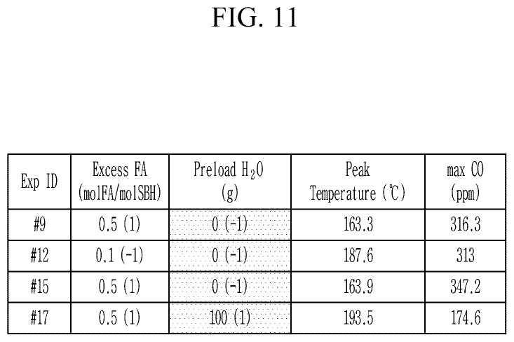

Referring to the “P” marker in FIG. 9, experiment #17 exhibited a relatively high level of carbon monoxide (CO) generation despite a low formic acid (FA) concentration, suggesting that multiple secondary factors may have contributed to this (e.g., exceptional) result. Further details are described with reference to FIGS. 10 and 11.

Referring to the “Q” and “S” regions in FIG. 9, certain experiments (#2 and #3) exhibited low carbon monoxide (CO) generation despite high formic acid (FA) concentrations and the absence of water (H₂O) loading, which appears to be attributable either to significantly lower peak temperatures or to the combined influence of other secondary factors. Another factor may be the low concentration of the SBH aqueous solution, which could result in a relatively slower reaction rate.

Referring to the “R” region in FIG. 9, experiment #4 exhibited an unusually high maximum carbon monoxide (CO) generation despite a low formic acid (FA) concentration, suggesting that multiple secondary factors may have contributed to this (e.g., exceptional) result. Another factor appears to be the initial exotherm caused by the NaOH-FA acid-base neutralization reaction due to increased NaOH usage.

Referring to FIGS. 10A, 10B, 10C, and 10D and FIG. 11, experiment #17 demonstrated a cumulative CO output, similar to those of experiments #9 and #12, despite having a relatively low formic acid (FA) concentration. For experiments #9 and #12, the elevated FA concentration caused an accelerated reaction at the initial stage of SBH aqueous solution injection, and the associated instantaneous exothermic response is understood (e.g., believed) to have contributed to the generation of carbon monoxide (CO). In experiment #17, despite the low FA concentration, the use of a large quantity of NaOH led to sustained heat release from the neutralization reaction with FA, thereby maintaining an elevated reaction temperature and causing continuous, low-level CO generation over the course of the reaction. Experiment #17 demonstrated sustained thermal conditions exceeding 160° C. throughout a significant portion of the reaction period.

Based on these experimental results, it may be concluded that a key factor influencing carbon monoxide (CO) generation is the temperature of the dehydrogenation reactor 40, and that the reactor temperature is impacted (e.g., affected) by the concentration of the reactants and an amount of neutralizing agent (NaOH) used. Variations in reactant concentration result in corresponding changes in reaction kinetics, which in turn influence the localized or overall thermal conditions of the reactor.

The SBH aqueous solution, as a reactant, may contain up to 25 wt % to remain in the liquid phase, whereas the formic acid (FA) may have a broader concentration range of 0 to 100 wt %, thereby exerting a greater influence on the reaction temperature. A temperature effect associated with the neutralizing agent NaOH may originate (e.g., exclusively) from the acid-base neutralization reaction (e.g., not from the exothermic hydrogen generation), and as the chemical hydride aqueous solution containing NaOH is stored in a chemical hydride tank (30), whose temperature is regulated within a specified range (e.g., 5° C. to 20° C.) by a thermal control unit, (e.g., excessive) addition of the neutralizing agent may be unnecessary, thereby minimizing its thermal influence.

In conclusion, the (e.g., key) factors influencing carbon monoxide (CO) generation may be the reactor temperature and the concentration of formic acid (FA). Accordingly, in an example embodiment, the amount of carbon monoxide (CO) generated during the reaction between the acidic aqueous solution and the chemical hydride may be minimized by controlling the injection rate of the chemical hydride or by additionally supplying water into the dehydrogenation reactor 40 such that the reactor temperature does not exceed a first set temperature (e.g., 160° C.), and by maintaining the molar ratio of the acidic aqueous solution within a predetermined range (e.g., 20 mol % to 50 mol %).

As described herein, in the SBH compressor system operated under a high-pressure condition, liquefaction of SBH reduces (e.g., is essential in order to reduce) hydrogen loss and by-product generation, and improves (e.g., to enhance) reactivity.

Although liquefaction of SBH alone improves fluidity and provides (e.g., enables) continuous reaction, thereby reducing hydrogen loss and providing (e.g., enhancing) reactivity, the reaction temperature and by-product generation may still be (e.g., significantly) affected by the mixing conditions and injection sequence of the reactants.

When applying the injection order of the acid aqueous solution and chemical hydride aqueous solution, the concentration of the acid aqueous solution (e.g., about 20 to about 50 mol %), and the storage conditions of the chemical hydride aqueous solution (e.g., about 5 to about 20 degrees Celsius) presented in the present disclosure, a thermal effect of acid-base neutralization may be mitigated and localized temperature elevation due to water's heat absorption may be avoided, and consequently, the reaction temperature may remain (e.g., uniformly) stable, leading to a reduction in side reactions and associated by-product generation.

Experimental results indicate that (e.g., the effect of) reducing side reactions may vary by several tens of times depending on the applied conditions.

As described herein, in an example embodiment, the concentration range of formic acid (FA) in the acidic aqueous solution may be from about 20 mol % to about 50 mol %. The amount of formic acid (FA) may be determined by the concentration of NaOH in the SBH aqueous solution and the molar ratio between SBH and FA. The NaOH concentration may reflect the amount of NaOH added to the SBH aqueous solution for neutralization by FA, whereas an SBH-to-FA molar ratio serves to provide (e.g., define) the (e.g., requisite) FA quantity for reaction with SBH.

In FIGS. 7A and 7B, for example, when the NaOH concentration is 1 wt %, the excess FA amount is 0.5, and the amount of water is 100 g, the FA concentration may be approximately 21 mol %. Furthermore, when the NaOH concentration is 7 wt %, the excess FA amount is 0.5, and the water content is 50 g, the FA concentration may be approximately 48 mol %. Accordingly, based on the experimental conditions, the concentration of formic acid (FA) may be determined to fall within the range of 20 mol % to 50 mol %.

While this disclosure has been described in connection with example embodiments, it is to be understood that the present disclosure is not limited thereto the disclosed embodiments, but, on the contrary, is intended to cover various modifications and equivalent arrangements.

What is claimed is:

1. A dehydrogenation reaction system comprising:
a dehydrogenation reactor configured to generate a hydrogen gas through a chemical reaction between a chemical hydride aqueous solution and an acidic aqueous solution;
an acid tank configured to store acid supplied to the dehydrogenation reactor;
a chemical hydride tank configured to store a chemical hydride aqueous solution containing a neutralizing agent supplied to the dehydrogenation reactor; and
a controller comprising a memory storing computer-executable instructions, and at least one processor configured to access the memory and execute the instructions, wherein the instructions comprise:
supplying a first predetermined amount of water and a second predetermined amount of acidic aqueous solution to the dehydrogenation reactor; and,
after the water and the acidic aqueous solution are supplied to the dehydrogenation reactor, supplying a chemical hydride aqueous solution to the dehydrogenation reactor at a first predetermined flow rate.

2. The dehydrogenation reaction system of claim 1, further comprising:
a water tank configured to store water supplied to the dehydrogenation reactor.

3. The dehydrogenation reaction system of claim 2, wherein
if an internal temperature of the dehydrogenation reactor is greater than a first predetermined temperature,
the instructions further comprise supplying the chemical hydride aqueous solution at a second predetermined flow rate to the dehydrogenation reactor, wherein the second predetermined flow rate is slower than the first predetermined flow rate.

4. The dehydrogenation reaction system of claim 2, wherein
if an internal temperature of the dehydrogenation reactor is greater than a first predetermined temperature,
the instructions further comprise additionally supplying water to the dehydrogenation reactor.

5. The dehydrogenation reaction system of claim 3, wherein
after a third predetermined amount of chemical hydride is supplied to the dehydrogenation reactor, when an internal temperature of the dehydrogenation reactor is equal to or greater than the second predetermined temperature,
the instructions further comprise additionally supplying water to the dehydrogenation reactor.

6. The dehydrogenation reaction system of claim 3, wherein
after a third predetermined amount of chemical hydride is supplied to the dehydrogenation reactor, when an internal temperature of the dehydrogenation reactor is less than the second predetermined temperature,
the instructions further comprise discharging a product of the dehydrogenation reactor into a product tank.

7. The dehydrogenation reaction system of claim 2, wherein
an acid solution supplied to the dehydrogenation reactor has a molar ratio within a predetermined range relative to water.

8. The dehydrogenation reaction system of claim 7, wherein the molar ratio of the predetermined range has about 20 mol % to about 50 mol %.

9. The dehydrogenation reaction system of claim 2, further comprising
a thermal management device provided in the chemical hydride tank and configured to maintain a temperature of the chemical hydride tank within a predetermined temperature range.

10. The dehydrogenation reaction system of claim 9, wherein
the predetermined temperature range
is about 5 degrees Celsius to about 20 degrees Celsius.

11. The dehydrogenation reaction system of claim 9, wherein
the thermal management device
includes at least one of a cooling coil provided inside the chemical hydride tank;
a cooling jacket provided outside the chemical hydride tank; or
a cooling bath configured to accommodate the chemical hydride tank therein.

12. The dehydrogenation reaction system of claim 1, wherein
an operating temperature for a reaction between the acidic aqueous solution and the chemical hydride aqueous solution in the dehydrogenation reactor may be maintained at or below about 120 degrees Celsius.

13. A control method for a dehydrogenation reaction system, the method comprising:
supplying a first predetermined amount of water to a dehydrogenation reactor;
supplying a second predetermined amount of acid aqueous solution to the dehydrogenation reactor; and
supplying a chemical hydride solution containing a neutralizing agent to the dehydrogenation reactor at a first predetermined flow rate, after the water and the acidic aqueous solution are supplied to the dehydrogenation reactor.

14. The control method of claim 13, further comprising:
determining an internal temperature of the dehydrogenation reactor and determining if the internal temperature of the dehydrogenation reactor exceeds a first predetermined temperature; and
supplying the chemical hydride solution to the dehydrogenation reactor at a second predetermined flow rate when the internal temperature of the dehydrogenation reactor exceeds the first predetermined temperature, wherein the second predetermined flow rate is slower than the first predetermined flow rate.

15. The control method of claim 14, further comprising:
determining if a third predetermined amount of chemical hydride aqueous solution has been supplied to the dehydrogenation reactor;
determining if the internal temperature of the dehydrogenation reactor is below a second predetermined temperature, after the third predetermined amount of chemical hydride aqueous solution has been supplied to the dehydrogenation reactor; and
discharging a product of the dehydrogenation reactor to a product tank or additionally supplying water to the dehydrogenation reactor based on the internal temperature of the dehydrogenation reactor.

16. The control method of claim 15, further comprising
if an internal temperature of the dehydrogenation reactor is less than a second predetermined temperature,
discharging the product of the dehydrogenation reactor into the product tank.

17. The control method of claim 15, further comprising
if an internal temperature of the dehydrogenation reactor is equal to or greater than a second predetermined temperature,
additionally supplying water to the dehydrogenation reactor.

18. The control method of claim 13, wherein
an acidic aqueous solution supplied to the dehydrogenation reactor has a molar ratio within a predetermined range relative to the water.

19. The control method of claim 18, wherein
the molar ratio of the predetermined range
is about 20 mol % to about 50 mol %.

20. The control method of claim 13, wherein
a chemical hydride tank maintains a predetermined temperature range.
